(19) United States
(12) Patent Application Publication
(10) Pub. No.: US 2024/0061931 A1
(43) Pub. Date: Feb. 22, 2024

(54) EXECUTABLE FILE UNPACKING SYSTEM AND METHOD FOR STATIC ANALYSIS OF MALICIOUS CODE

(71) Applicant: MONITORAPP CO., LTD., Seoul (KR)

(72) Inventors: Young Jung KIM, Gunpo-si, Gyeonggi-do (KR); Doo Hwan KIM, Seoul (KR)

(73) Assignee: MONITORAPP CO., LTD., Seoul (KR)

(21) Appl. No.: 18/259,296

(22) PCT Filed: Dec. 2, 2021
(86) PCT No.: PCT/KR2021/018068

§ 371 Date: Jun. 26, 2023

(30) Foreign Application Priority Data
Jan. 5, 2021 (KR) 10-2021-0000707

(51) Int. Cl. G06F 21/55

(52) U.S. Cl. CPC G06F 21/554; G06F 2221/033

(57) ABSTRACT

The present invention relates to an executable file unpacking system and method for static analysis of a malicious code, in which the method according to the present invention includes: a pre-analysis step of receiving an input of a file to be detected, identifying whether the received file is a binary file, and extracting a hash value when the file to be detected is a binary file; a step of searching a database for a malicious code hash value corresponding to the extracted hash value; a step of, when the malicious code hash value corresponding to the extracted hash value is not found, detecting a packer for the file to be detected using a signature-based packer detection module; and a step of, when the packer for the file to be detected is not detected at the signature-based packer detection module, guessing whether the file is packed or not using an entropy-based packer detection module. According to the present invention, there are advantages that the possibility of detecting malicious code is increased, and that the detection can be performed quickly.

### TECHNICAL FIELD

The present invention relates to an executable file unpacking system and method for static analysis of malicious code.

### BACKGROUND ART

Malicious codes may pose a serious threat to computer systems and are mostly distributed through executable files downloaded through various routes such as the web, file servers, and e-mails. If a user executes an executable file including malicious behavior, it will directly lead into infection with the malicious codes. When a computer system is infected with the malicious code, serious damages such as stealing of personal information, slowing down speed, and deletion of important files occur.

In order to prevent damages from malicious code infection, user must scan in advance through an antivirus program and the like before executing the executable file, but it is not that easy. It may be effective to detect malicious code through static analysis that analyze an executable file as it is without executing the executable file quickly at the system level before the executable file is delivered to the user and executed. Since most of malicious codes are packed, detection and removal of packers are essential for effective static analysis.

In most computer systems, real time analysis is performed through an antivirus program, but in the case of packed executable files, malicious codes are often not detected through static analysis due to internal processes such as antivirus evasion, time delay, and logic bypass.

In order to detect malicious information more accurately, dynamic analysis method that detects malicious codes through direct execution in a virtual machine can be used, but it is difficult to apply it in real time basis due to time and cost issues. In addition, conventionally, there is an inconvenience of having to generate and analyze unpacked files using packer individual unpacking tools according to various types of packers.

In conclusion, in order to effectively detect malicious code hidden in the executable file, a technology and a platform to which the technology is applied are necessary, which are capable of quickly analyzing the corresponding executable file to check for packing and detecting the type of packer used, creating an unpacked file through unpacking, and detecting malicious information through static analysis.

### DETAILED DESCRIPTION OF INVENTION

### Technical Problem

Therefore, a technical problem to be solved by the present invention is to provide an executable file unpacking system and method for static analysis of a malicious code, which are capable of detecting and unpacking a packed file in which a malicious code is hidden so as to prevent it in advance through static analysis.

### Technical Solution

In order to accomplish the technical objectives mentioned above, an executable file unpacking method for static analysis of malicious code includes a pre-analysis step of receiving an input of a file to be detected, identifying whether the received file is a binary file, and extracting a hash value when the file to be detected is a binary file, a step of searching a database for a malicious code hash value corresponding to the extracted hash value, a step of, when the malicious code hash value corresponding to the extracted hash value is not found, detecting a packer for the file to be detected using a signature-based packer detection module, and a step of, when the packer for the file to be detected is not detected at the signature-based packer detection module, guessing whether the file is packed or not using an entropy-based packer detection module.

The signature-based packer detection module may detect a packer by matching information extracted by parsing a byte pattern from an entry point (EP) of the file to be detected with packer signature information loaded from a database.

The method may further include a step of recovering import address table (IAT) of the file to be detected using an unpacker library corresponding to the packer detected by the signature-based detection, and then unpacking the file to be detected through a memory dump at an original entry point (OEP).

The entropy-based packer detection module may extract an entropy value of the file to be detected and compare the extracted value with a predefined threshold so as to guess whether the file is packed or not.

The method may further include a step of, when it is guessed by the entropy-based detection that the file is packed, recovering IAT by tracing from an EP of the file to be detected and then unpacking the file to be detected through a memory dump at an OEP of the file to be detected.

A section for recording threat information including API call information and library call information may be added to the unpacked file to be detected.

A computer-readable recording medium according to another embodiment of the present invention records a program for executing, on a computer, any one of the methods described above.

In order to accomplish the technical objectives mentioned above, an executable file unpacking system for static analysis of malicious code may includes a pre-analysis unit that receives an input of a file to be detected, identifies whether the received file is a binary file, extracts a hash value when the file to be detected is a binary file, and searches a database for a malicious code hash value corresponding to the extracted hash value, a signature-based packer detection module that, when the malicious code hash value corresponding to the extracted hash value is not found, detects a packer for the file to be detected by signature-based detection, and an entropy-based packer detection module that, when the packer for the file to be detected is not detected at the signature-based packer detection module, guesses whether the file is packed or not by entropy-based detection.

A method according to another embodiment of the present invention may include a pre-analysis step of receiving an input of a file to be detected, identifying whether the received file is a binary file, and extracting a hash value when the file to be detected is a binary file, a step of searching a database for a malicious code hash value corresponding to the extracted hash value, a step of, when the malicious code hash value corresponding to the extracted hash value is not found, detecting a packer for the file to be detected using a signature-based packer detection module, a step of, when the packer for the file to be detected is not detected at the signature-based packer detection module, guessing whether the file is packed or not using an entropy-based packer detection module, wherein the signature-based packer detection module may detect a packer by matching information extracted by parsing a byte pattern from an entry point (EP) of the file to be detected with packer signature information loaded from a database, a step of recovering import address table (IAT) of the file to be detected using an unpacker library corresponding to the packer detected by the signature-based detection, and then unpacking the file to be detected through a memory dump at an original entry point (OEP), wherein the entropy-based packer detection module may extract the entropy value of the file to be detected and compare the value with a predefined threshold to guess whether the file is packed or not, and a step of, when it is guessed by the entropy-based detection that the file is packed, recovering IAT by tracing from an EP of the file to be detected and then unpacking the file to be detected through a memory dump at an OEP of the file to be detected, in which a section for recording threat information including API call information and library call information may be added to the unpacked file to be detected.

A system according to another embodiment of the present invention may include a pre-analysis unit that receives an input of a file to be detected, identifies whether the received file is a binary file, extracts a hash value when the file to be detected is a binary file, and searches a database for a malicious code hash value corresponding to the extracted hash value, a signature-based packer detection module that, when the malicious code hash value corresponding to the extracted hash value is not found, detects a packer for the file to be detected by signature-based detection, an entropy-based packer detection module that, when the packer for the file to be detected is not detected at the signature-based packer detection module, guesses whether the file is packed or not by entropy-based detection, a packer-based unpacking module that recovers import address table (IAT) of the file to be detected using an unpacker library corresponding to the packer detected by the signature-based detection, and then unpacks the file to be detected through a memory dump at an original entry point (OEP), and an OEP search-based unpacking module that, when it is guessed by the entropy-based detection that the file is packed, recovers IAT by tracing from an entry point (EP) of the file to be detected and then unpacks the file to be detected through a memory dump at an original entry point (OEP) of the file to be detected, in which the signature-based packer detection module may detect a packer by matching information extracted by parsing a byte pattern from the EP of the file to be detected with packer signature information loaded from a database, the entropy-based packer detection module may extract the entropy value of the file to be detected and compare the value with a predefined threshold to guess whether the file is packed or not, and a section for recording threat information including API call information and library call information may be added to the unpacked file to be detected.

### Effects of Invention

According to the present invention, there are advantages that the possibility of detecting malicious code is increased, and that the detection can be performed quickly.

### BRIEF DESCRIPTION OF THE DRAWINGS

FIG. 1 is a configuration diagram of an executable file unpacking system for static analysis of a malicious code according to an embodiment of the present invention.

FIG. 2 is a flowchart of operations of an executable file unpacking system for static analysis of a malicious code according to an embodiment of the present invention.

### MODE FOR EMBODYING INVENTION

Hereinafter, embodiments of the present invention will be described in detail with reference to the accompanying drawings to assist those with ordinary knowledge in the art to which the present invention belongs to easily achieve the present invention.

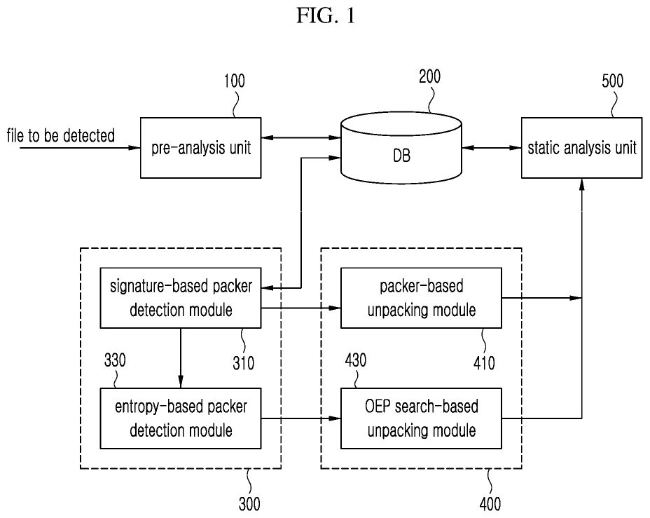

FIG. 1 is a configuration diagram of an executable file unpacking system for static analysis of a malicious code according to an embodiment of the present invention.

Referring to FIG. 1, the system according to the present invention may include a pre-analysis unit 100, a database 200, a packer detection unit 300, an unpacking unit 400, and a static analysis unit 500.

The pre-analysis unit 100 receives an input of a file to be detected and checks whether the file is a binary file. If the file to be detected is a binary file, the pre-analysis unit 100 may extract a hash value and search the database 200 for a malicious code hash value corresponding to the extracted hash value, and quickly check whether the corresponding file has a history of being recently detected as malicious.

The database 200 may store various types of information and data related to the operation of the system according to the present invention. In detail, the database 200 may store unique hash information of the file detected as malicious. In addition, the database 200 may also store signature information of the previously known packers. In addition, the database 200 may also store information on a threshold that is a criterion for guessing whether the file is packed. In addition, the database 200 may store an unpacker library, which modularizes an unpacking logic corresponding to each of the previously known packers.

The packer detection unit 300 may include a signature-based packer detection module 310 and an entropy-based packer detection module 330.

The signature-based packer detection module 310 detects a packer by the signature-based detection for the file to be detected that is a binary file.

The signature-based packer detection module 310 may detect the packer by parsing the byte pattern from the entry point (EP) of the file to be detected and matching the extracted information (OPCODE) with the packer signature information loaded from the database 200.

The entropy-based packer detection module 330 may guess, based on entropy, whether the file to be detected that is the binary file is packed.

The entropy-based packer detection module 330 extracts the entropy value of the file to be detected and compares the extracted value with a predefined threshold to guess whether the file is packed or not. If the entropy value of the file to be detected is greater than the threshold, it may be guessed that the file is packed, and otherwise, it may be guessed that the file is not packed.

The unpacking unit 400 may perform unpacking on the file to be detected, and may include a packer-based unpacking module 410 and an OEP search-based unpacking module 430 for this purpose.

The packer-based unpacking module 410 may recover import address table (IAT) of the file to be detected using an unpacker library corresponding to the packer detected by the signature-based detection, and may recover, that is, may unpack the file to be detected through a memory dump at an original entry point (OEP).

The OEP search-based unpacking module 430 may recover the IAT by tracing from the EP of the file to be detected that is guessed to be packed by the entropy-based detection, and then restore and unpack the file to be detected through the memory dump at the OEP of the file to be detected.

The packer-based unpacking module 410 and the OEP search-based unpacking module 430 may add a threat information recording section that records threat information including API call information and library call information to the unpacked file to be detected during the unpacking process.

For example, after unpacking the file, the packer-based unpacking module 410 and the OEP search-based unpacking module 430 may add metadata such as threat information, hash information, IAT information, file section and memory protection policy, decryption control flow, and function call information to a specific section generated by itself in the unpacked file to facilitate static analysis of malicious code.

The packer-based unpacking module 410 and the OEP search-based unpacking module 430 may rearrange memory address values so that the unpacked file to be detected including the threat information section can be executed.

Meanwhile, some malicious codes have a vulnerability of avoiding scanning by embedding malicious behavior execution codes in overlay data. Therefore, the packer-based unpacking module 410 and the OEP search-based unpacking module 430 may copy the overlay data, which is ignored when the executable file is loaded into memory, to the threat information recording section so that it may be of use during static analysis.

The static analysis unit 500 may detect the malicious code through static analysis that extracts and analyzes information of a binary file itself without executing the unpacked file to be detected, the binary file. In particular, fast malicious detection is possible through the use of the threat information recording section newly added to the file to be detected during the unpacking process.

In this way, the results of packer detection and unpacking of the binary file and the result of static analysis may be stored in the database 200 based on the unique hash information of the corresponding file for future use.

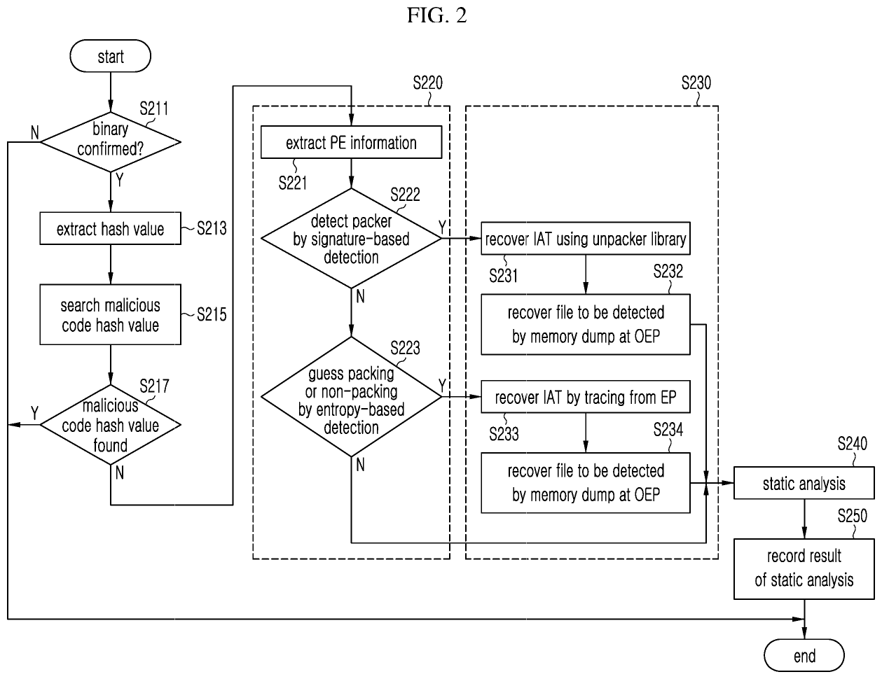

FIG. 2 is a flowchart of operations of an executable file unpacking system for static analysis of a malicious code according to an embodiment of the present invention.

Referring to FIGS. 1 and 2, first, the pre-analysis unit 100 receives an input of a file to be detected and checks whether the file is a binary file (S211). If the file to be detected is a binary file (S211-Y), the pre-analysis unit 100 may extract a hash value (S213), search the database 200 for a malicious code hash value corresponding to the extracted hash value (S215), and determine quickly whether or not the corresponding file is malicious according to whether or not there is a malicious code hash value (S217).

If the file is not the binary file (S211-N), the pre-analysis unit 100 delivers an error result and ends the operation. Meanwhile, when confirming the malicious code hash value corresponding to the extracted hash value (S217-Y), the pre-analysis unit 100 may transfer the malicious code detection result and end the process.

Meanwhile, if there is no malicious code hash value corresponding to the extracted hash value (S217-N), the packer detection unit 300 detects whether the file to be detected is packed (S220).

First, the packer detection unit 300 extracts PE information from the file to be detected (S221). Then, through the signature-based packer detection module 310, signature-based packer detection is performed for the file to be detected that is the binary file (S222).

If the packer is not detected with the signature-based detection (S222-N), the entropy-based detection may be performed using the entropy-based packer detection module 330 so as to guess whether or not the file to be detected that is a binary file is packed (S223).

Then, if a packer is detected by the signature-based detection or if it is guessed by the entropy-based detection that the file to be detected is packed, the unpacking unit 400 unpacks the file to be detected (S230).

If the packer is detected by the signature-based detection (S222-Y), the packer-based unpacking module 410 may receive a corresponding packer name from the packer detection unit 300, recover the IAT of the file to be detected using the unpacker library corresponding to the corresponding packer (S231), and recover the file to be detected through a memory dump at the OEP of the file to be detected (S232).

If it is guessed by the entropy-based detection that the file to be detected is packed (S223-Y), the OEP search-based unpacking module 430 may recover the IAT by tracing from the EP of the file to be detected (S233), and recover the file to be detected through a memory dump at the OEP of the file to be detected (S234).

Meanwhile, in steps S232 and S234, the packer-based unpacking module 410 and the OEP search-based unpacking module 430 may add a threat information recording section that records threat information including API call information and library call information to the unpacked file to be detected during the unpacking process.

Then, the static analysis unit 500 may detect malicious code through static analysis that extracts and analyzes information of the binary file itself without executing the unpacked file to be detected, the binary file (S240). In addition, if it is guessed by the entropy-based detection that the file to be detected is not packed (S223-N), the static analysis unit 500 may detect malicious code through static analysis without unpacking the file to be detected (S240).

The static analysis unit 500 records the malicious code detection result in the database 200 at S240 and ends the process (S250).

In this way, according to the present invention, an integrated system can be built by modularizing various types of known unpacking tools with modules that quickly analyze the binary files to check whether or not the files are packed and detect the types of packers used, and, for unknown packers, loading a module that uses a method of searching original entry point (OEP) to perform unpacking. The unpacked file extracted as a result can be added with a specific binary section to separately include information useful for malicious detection, such that quick static analysis is possible.

In this way, it is possible to modularize the methods of analyzing and undoing various packer techniques into one integrated system, and make each module universal, making it usable in various systems. In addition, the signature database that plays an important role in detection, and the unpacker library that plays an important role in unpacking can be updated easily so that it is possible to respond to a new type of packer. In particular, fast static analysis is possible by separately recording static information useful for malicious detection in a specific section. Using this, it is possible to efficiently respond to attacks in various forms in the system and service areas, rather than the user area.

The embodiments described above may be implemented as a hardware component, a software component, and/or a combination of a hardware component and a software component. For example, the devices, methods, and components described in the embodiments may be implemented by using one or more general computer or specific-purpose computer such as a processor, a controller, an arithmetic logic unit (ALU), a digital signal processor, a microcomputer, a field programmable gate array (FPGA), a programmable logic unit (PLU), a microprocessor, or any other device capable of executing instructions and responding thereto. The processing device may execute an operating system (OS) and one or more software applications executed on the operating system. Further, the processing device may access, store, operate, process, and generate data in response to the execution of software. For convenience of understanding, it is described in certain examples that one processing device is used, but one of ordinary skill in the art may understand that the processing device may include a plurality of processing elements and/or a plurality of types of processing elements. For example, the processing device may include a plurality of processors or one processor and one controller. In addition, other processing configurations such as a parallel processor are possible.

The software may include a computer program, code, instructions, or a combination of one or more of the above, and may configure the processing device, or instruct the processing device independently or collectively to operate as desired. Software and/or data may be interpreted by the processing device or, in order to provide instructions or data to the processing device, may be embodied in any type of machine, component, physical device, virtual equipment, computer storage medium or device, or signal wave transmission, permanently or temporarily. The software may be distributed over networked computer systems and stored or executed in a distributed manner. The software and data may be stored on one or more computer-readable recording media.

The method according to the embodiments may be implemented in the form of program instructions that can be executed through various computer means and recorded in a computer-readable medium. The computer readable medium may include program instructions, data files, data structures, and the like alone or in combination. The program instructions recorded on the medium may be those specially designed and configured for the purposes of the embodiments, or may be known and available to those skilled in computer software. Examples of computer readable recording medium include magnetic media such as hard disks, floppy disks, and magnetic tape, optical media such as CD-ROMs and DVDs, magneto-optical media such as floptical disks, and hardware devices specifically configured to store and execute program instructions such as ROM, RAM, flash memory, and the like. Examples of the program instructions include machine language codes such as those generated by a compiler, as well as high-level language codes that may be executed by a computer using an interpreter, and so on. The hardware device described above may be configured to operate as one or more software modules in order to perform the operations according to the embodiments, and vice versa.

As described above, although the embodiments have been described with reference to the limited drawings, a person of ordinary skill in the art can apply various technical modifications and variations based on the above. For example, even when the described techniques are performed in the order different from the method described above, and/or even when the components of the system, structure, device, circuit, and the like are coupled or combined in a form different from the way described above, or replaced or substituted by other components or equivalents, an appropriate result can be achieved.

1. An executable file unpacking method for static analysis of malicious code, the method comprising:
a pre-analysis step of receiving an input of a file to be detected, identifying whether the received file is a binary file, and extracting a hash value when the file to be detected is a binary file;
a step of searching a database for a malicious code hash value corresponding to the extracted hash value;
a step of, when the malicious code hash value corresponding to the extracted hash value is not found, detecting a packer for the file to be detected using a signature-based packer detection module; and
a step of, when the packer for the file to be detected is not detected at the signature-based packer detection module, guessing whether the file is packed or not using an entropy-based packer detection module.

2. The method of claim 1, wherein the signature-based packer detection module detects a packer by matching information extracted by parsing a byte pattern from an entry point (EP) of the file to be detected with packer signature information loaded from a database.

3. The method of claim 2, further comprising a step of recovering import address table (IAT) of the file to be detected using an unpacker library corresponding to the packer detected by the signature-based detection, and then unpacking the file to be detected through a memory dump at an original entry point (OEP).

4. The method of claim 1, wherein the entropy-based packer detection module extracts an entropy value of the file to be detected and compares the extracted value with a predefined threshold so as to guess whether the file is packed or not.

5. The method of claim 4, further comprising a step of, when it is guessed by the entropy-based detection that the file is packed, recovering IAT by tracing from an EP of the file to be detected and then unpacking the file to be detected through a memory dump at an OEP of the file to be detected.

6. The method of claim 5, wherein a section for recording threat information including API call information and library call information is added to the unpacked file to be detected.

7. A computer-readable recording medium storing a program for executing the method of claim 1 on a computer.

8. An executable file unpacking system for static analysis of malicious code, the system comprising:
a pre-analysis unit that receives an input of a file to be detected, identifies whether the received file is a binary file, extracts a hash value when the file to be detected is a binary file, and searches a database for a malicious code hash value corresponding to the extracted hash value;
a signature-based packer detection module that, when the malicious code hash value corresponding to the extracted hash value is not found, detects a packer for the file to be detected by signature-based detection; and
an entropy-based packer detection module that, when the packer for the file to be detected is not detected at the signature-based packer detection module, guesses whether the file is packed or not by entropy-based detection.

9. The system of claim 8, wherein the signature-based packer detection module detects a packer by matching information extracted by parsing a byte pattern from an entry point (EP) of the file to be detected with packer signature information loaded from a database.

10. The system of claim 9, further comprising a packer-based unpacking module that recovers import address table (IAT) of the file to be detected using an unpacker library corresponding to the packer detected by the signature-based detection, and then unpacks the file to be detected through a memory dump at an original entry point (OEP).

11. The system of claim 8, wherein the entropy-based packer detection module extracts an entropy value of the file to be detected and compares the extracted value with a predefined threshold so as to guess whether the file is packed or not.

12. The system of claim 11, further comprising an OEP search-based unpacking module that, when it is guessed by the entropy-based detection that the file is packed, recovers IAT by tracing from an EP of the file to be detected and then unpacks the file to be detected through a memory dump at an OEP of the file to be detected.

13. The system of claim 12, wherein a section for recording threat information including API call information and library call information is added to the unpacked file to be detected.
